(19) United States
(12) Patent Application Publication
(10) Pub. No.: US 2017/0082210 A1
(43) Pub. Date: Mar. 23, 2017

(54) DIAPHRAGM STRUCTURE AND DIAPHRAGM VALVE INCLUDING SAME

(71) Applicant: Bitron Ind. China Co., Ltd., Qingdao (CN)

(72) Inventor: Dae Hong OK, Gyeonggi-do (KR)

(21) Appl. No.: 15/264,849

(22) Filed: Sep. 14, 2016

(30) Foreign Application Priority Data
Sep. 17, 2015 (KR) 10-2015-0131868

(51) Int. Cl. F16K 7/14; B01D 35/04

(52) U.S. Cl. CPC F16K 7/14; B01D 35/04

(57) ABSTRACT

A diaphragm structure includes a vibrator, a first guide inserted into a lower side of the vibrator, a second guide inserted into a lower side of the first guide and having a part protruding from an upper side of the vibrator, and a filtering member configured to filter introduced foreign matter.

### CROSS-REFERENCE TO RELATED APPLICATION

This application claims priority to and the benefit of Korean Patent Application No. 2015-0131868, filed on Sep. 17, 2015, the disclosure of which is incorporated herein by reference in its entirety.

### BACKGROUND

1. Field of the Invention

The present invention relates to a diaphragm structure and a diaphragm valve including same.

2. Discussion of Related Art

A diaphragm valve refers to a valve that adjust a flow of a fluid in the valve according to whether or not a diaphragm guide therein abutting the valve is in close contact with the valve. In order to move the diaphragm guide when liquid such as water flows into the diaphragm valve, holes are formed in the diaphragm guide. As a pressure with respect to the diaphragm guide is formed while the fluid passes through the holes formed in the diaphragm guide, whether or not the diaphragm guide is in close contact with the valve may be adjusted.

However, since the diaphragm valve is used, the holes of the diaphragm guide can be blocked by foreign matter present in water. When the holes of the diaphragm guide are blocked, the water does not flow freely into the diaphragm guide and thus it is difficult to change the pressure with respect to the diaphragm guide. Thus, the overall operational reliability of the diaphragm valve can be reduced and a desired valve operation cannot be performed.

### SUMMARY

An embodiment of the present invention is directed to a diaphragm structure capable of preventing operational reliability from being reduced due to foreign matter, and a diaphragm valve including the same.

Further, an embodiment of the present invention is directed to a diaphragm structure capable of improving operational reliability even with a simple structure, and a diaphragm valve including the same.

According to an aspect of the present invention, there is provided a diaphragm structure including a vibrator, a first guide inserted into a lower side of the vibrator, a second guide inserted into a lower side of the first guide and having a part protruding from an upper side of the vibrator, and a filtering member configured to filter introduced foreign matter.

The filtering member may be included in the first guide.

The filtering member may be formed at an outer periphery of the first guide.

The filtering member may be formed separately from the first guide and the second guide.

The filtering member may have a slit shape.

The filtering member may have a mesh shape.

According to another aspect of the present invention, there is provided a diaphragm valve including the diaphragm structure.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is an exploded perspective view illustrating a diaphragm structure according to an embodiment of the present invention;

FIG. 2 is a cross-sectional view illustrating the diaphragm structure according to the embodiment of the present invention; and

FIG. 3 is a cross-sectional view illustrating a diaphragm valve including the diaphragm structure according to the embodiment of the present invention.

### DETAILED DESCRIPTION OF EXEMPLARY EMBODIMENTS

Hereinafter, exemplary embodiments of the invention will be described in detail with reference to the drawings. However, these are only examples and the invention is not limited thereto.

In descriptions of the invention, when it is determined that detailed descriptions of related well-known functions unnecessarily obscure the gist of the invention, detailed descriptions thereof will be omitted. Some terms described below are defined by considering functions in the invention and meanings may vary depending on, for example, a user's or operator's intentions or customs. Therefore, the meanings of terms should be interpreted based on the scope throughout this specification.

The spirit and scope of the invention is defined by the appended claims. The following embodiments are only made to efficiently describe the technological scope of the invention to those skilled in the art.

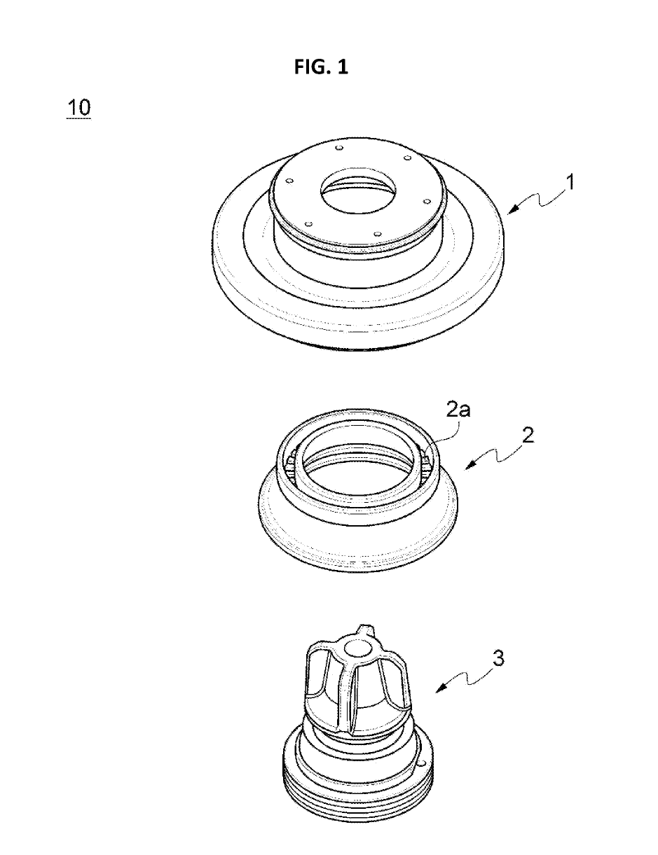

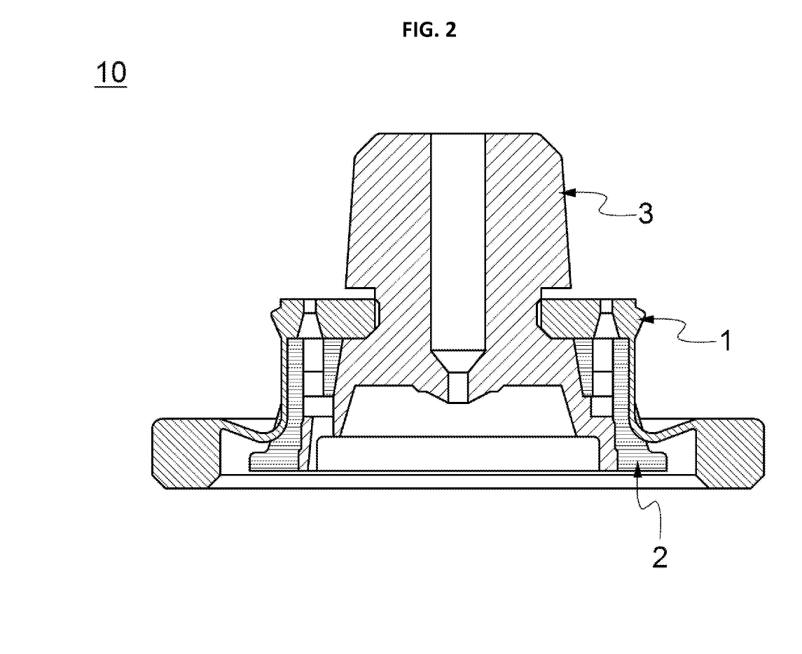

FIG. 1 is an exploded perspective view illustrating a diaphragm structure 10 according to an embodiment of the present invention, and FIG. 2 is a cross-sectional view illustrating the diaphragm structure 10 according to the embodiment of the present invention.

Referring to FIGS. 1 and 2, the diaphragm structure 10 may include a vibrator 1, a first guide 2 inserted into a lower side of the vibrator 1, and a second guide 3 inserted into a lower side of the first guide 2 and having a part protruding from an upper side of the vibrator 1.

The first guide 2 may include a filtering member 2a. The filtering member 2a may be a member for preventing an operation of a diaphragm valve from being interrupted due to the introduction of foreign matter, which is introduced into the diaphragm structure 10, into the diaphragm valve. The first guide 2 may be molded in plastic, and the filtering member 2a may be formed of the same material as the first guide 2. Further, the filtering member 2a may be formed simultaneously in a process of forming the first guide 2. That is, the first guide 2 including the filtering member 2a may be formed through injection molding and the like. Accordingly, a cost increase caused by the formation of the filtering member 2a may be minimized.

The filtering member 2a may be formed along an outer periphery of the first guide 2. The filtering member 2a may have a slit shape or a mesh shape. Since the diaphragm structure 10 may be moved smoothly in the diaphragm valve by the filtering member 2a according to water pressure, a problem may be prevented from occurring in the operation of the diaphragm valve.

In the present embodiment, the filtering member 2a is described as being included in the first guide 2, but the invention is not limited thereto. The filtering member 2a may also be formed separately from the first guide 2 and the second guide 3. That is, as the filtering member 2a is formed as a separate member having a mesh or screen form, the filtering member 2a may perform a filtering function by closely approaching any one of the first guide 2 and the second guide 3.

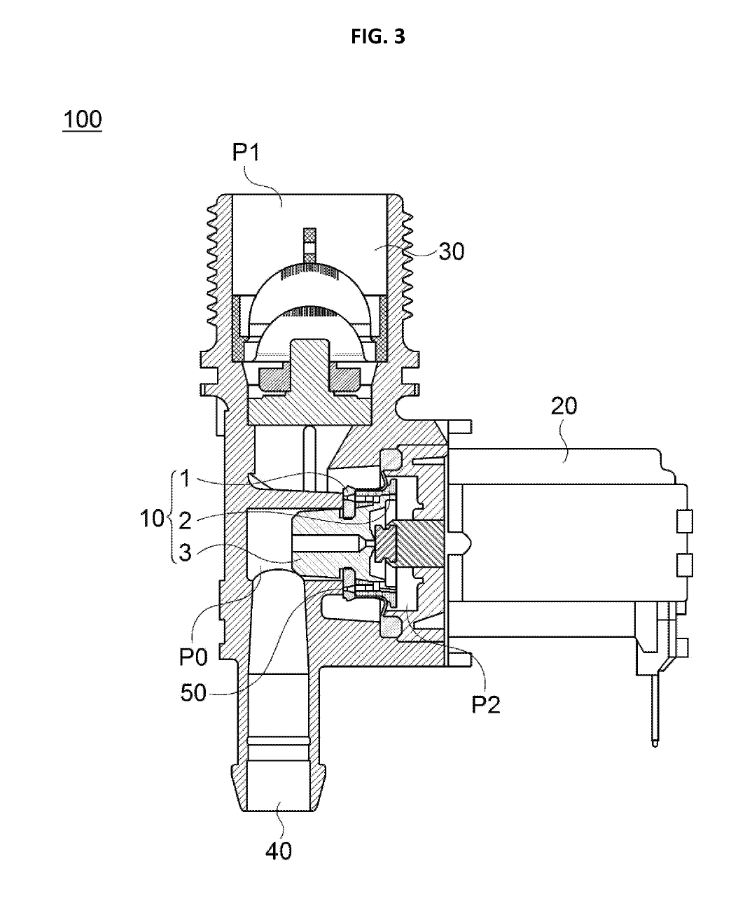

FIG. 3 is a cross-sectional view illustrating a diaphragm valve 100 including the diaphragm structure 10 according to the embodiment of the present invention.

Referring to FIG. 3, the diaphragm valve 100 may be driven as follows.

When a fluid (water) having a water pressure P1 is applied to a water inlet unit 30, an upper side of the diaphragm structure 10 may be filled with the fluid passing through holes formed in the diaphragm structure 10. When a solenoid 20 is in an off state, a pressure P1 of the water inlet unit 30 may be the same as a pressure P2 of the upper side of the diaphragm structure 10. In this case, an orifice 50 is closed by a force pressing the diaphragm structure 10 down, and thus the fluid may not be discharged to a water outlet unit 40.

At this time, a pressure P0 of an outside of the orifice 50 may be atmospheric pressure.

When the solenoid 20 is turned on, a central hole of the diaphragm structure 10 may be opened. Then, the fluid in the upper side of the diaphragm structure 10 passes through the central hole of the diaphragm structure 10, the pressure P2 of the upper side of the diaphragm structure 10 becomes lower than the pressure P1 of the water inlet unit 30, and the diaphragm structure 10 may be raised up by the water pressure of the water inlet unit 30. Therefore, the orifice 50 is opened and the fluid may be discharged to a side of the water outlet unit 40.

When the solenoid 20 is turned off again, the central hole of the diaphragm structure 10 is blocked, and the upper side of the diaphragm structure 10 may be refilled with the fluid through the holes formed in the diaphragm structure 10. Then, the orifice 50 is closed by the force pressing down at the upper side of the diaphragm structure 10, and thus the fluid may not be discharged to the water outlet unit 40.

Even when foreign matter is included in the fluid introduced from the water inlet unit 30 in this process, since the foreign matter is filtered by the filtering member 2a formed in the diaphragm structure 10, blockage of the holes through which the fluid flows by the foreign matter does not occur and it is thereby possible to prevent a problem in the operation of the diaphragm valve 100 from occurring.

According to the embodiments of the present invention, as a filtering member is formed in a diaphragm structure, operational reliability may be prevented from being reduced.

Further, according to the embodiments of the present invention, as a filtering member is formed in a first guide of a diaphragm structure or a separate filtering member is formed, operational reliability may be prevented from being reduced with only a simple configuration.

While the present invention has been described above in detail with reference to representative embodiments, it may be understood by those skilled in the art that the embodiment may be variously modified without departing from the scope of the present invention. Therefore, the scope of the present invention is defined not by the described embodiment but by the appended claims, and encompasses equivalents that fall within the scope of the appended claims.

What is claimed is:

1. A diaphragm structure, comprising:
a vibrator;
a first guide inserted into a lower side of the vibrator;
a second guide inserted into a lower side of the first guide and having a part configured to protrude from an upper side of the vibrator; and
a filtering member configured to filter introduced foreign matter.

2. The diaphragm structure of claim 1, wherein the filtering member is included in the first guide.

3. The diaphragm structure of claim 2, wherein the filtering member is formed at an outer periphery of the first guide.

4. The diaphragm structure of claim 1, wherein the filtering member is formed separately from the first guide and the second guide.

5. The diaphragm structure of claim 1, wherein the filtering member has a slit shape.

6. The diaphragm structure of claim 1, wherein the filtering member has a mesh shape.

7. A diaphragm valve comprising the diaphragm structure according to claim 1.
